(19) United States
(12) Patent Application Publication
(10) Pub. No.: US 2016/0037366 A1
(43) Pub. Date: Feb. 4, 2016

(54) DETECTION AND REPORTING OF NETWORK IMPAIRMENTS

(71) Applicant: Cox Communications, Inc., Atlanta, GA (US)

(72) Inventors: Jeff Finkelstein, Atlanta, GA (US); John Civiletto, Atlanta, GA (US)

(21) Appl. No.: 14/449,289

(22) Filed: Aug. 1, 2014

(51) Int. Cl. H04W 24/08

(52) U.S. Cl. CPC H04W 24/08; H04W 88/02

(57) ABSTRACT

Systems, methods, and computer-readable media are disclosed for providing terminal devices configured to collect network performance data, communicate the network performance data to one or more neighboring devices, and analyze the collected performance data and/or the received network performance data to identify anomalous data. The anomalous data may be communicated to a network management system which may, in turn, analyze the anomalous data to identify one or more network impairments. Additionally, or alternatively, a terminal device may be configured to identify a network impairment by correlating anomalous collected data to data received from neighboring terminal devices.

### BACKGROUND

Any of a variety of conditions may cause a network to operate less than optimally. Such conditions may include signal noise, damage to cables or connectors, data collisions on shared media, software failures, hardware failures, low bandwidth links, bandwidth congestion, signal modulation errors, and so forth. Less than optimal operation of a network may manifest itself in any of a variety of ways including, for example, packet loss, packet delay, packet reordering, packet duplication, packet corruption, and so forth.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily, the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic block diagram of an illustrative network architecture in accordance with one or more example embodiments of the disclosure.

FIG. 2 is a schematic block diagram of an illustrative terminal device in accordance with one or more example embodiments of the disclosure.

FIG. 3 is a schematic block diagram of an illustrative network management computing device in accordance with one or more example embodiments of the disclosure.

FIG. 4 is a process flow diagram of an illustrative method for identifying anomalous network performance data from collected network performance data and communicating collected network performance data to neighboring terminal devices to facilitate further identification of anomalous data by the neighboring devices in accordance with one or more example embodiments of the disclosure.

FIG. 5 is a process flow diagram of an illustrative method 500 for, among other things, receiving network performance data from neighboring terminal devices, identifying anomalous data based on a comparison of collected network performance data to the received network performance data, and transmitting information identifying at least a portion of the anomalous data to a network management system in accordance with one or more example embodiments of the disclosure.

FIG. 6 is a process flow diagram of an illustrative method for receiving information identifying anomalous network performance data and identifying a network impairment and a point of origin of the network impairment based at least in part on the anomalous data in accordance with one or more example embodiments of the disclosure.

### DETAILED DESCRIPTION

### Overview

This disclosure relates to, among other things, systems, methods, computer-readable media, techniques, and methodologies for collecting network performance data, analyzing the network performance data based on threshold performance criteria and/or network performance data received from other sources, identifying anomalous data based on the analysis, and reporting the anomalous data to one or more entities.

In accordance with one or more example embodiments of the disclosure, a cable system architecture may be provided that includes a head-end location at which broadcast cable signals may be received via one or more antennas. The received cable signals may be transmitted from the head-end location to terminal devices (e.g., customer premises equipment) via a network edge access device or termination system such as a cable modem termination system (CMTS). It should be appreciated that while example embodiments of the disclosure may be described herein in connection with a cable system architecture, embodiments of the disclosure are not limited to such an architecture or to any particular transmission method or protocol. For example, the network edge access device or termination system provided at a head-end, hub location, or other aggregation location may be any suitable generic conversion device or termination system (e.g., an optical line terminal (OLT), a wireless access point (WAP), etc.) that receives signals transmitted in accordance with a first transmission method (or protocol) and transmits the signals in accordance with a second transmission method (or protocol).

In those example embodiments involving a cable system architecture, a hybrid fiber-coax architecture may be employed. The hybrid fiber-coax architecture may include a network of optical fiber nodes connected to the head-end location via optical fiber links. Each fiber node may be connected via coaxial connections to a series of taps. Each tap may, in turn, be connected via coaxial connections to a group of terminal locations. Any of a variety of terminal devices may be provided as customer premises equipment at a terminal location. Such devices may include, without limitation, cable modems, set-top boxes, residential gateways, fixed mobile convergence devices, home networking adapters, or the like. In addition, terminal devices may include various consumer devices (e.g., smartphones, tablets, content streaming devices, etc.).

In accordance with one or more example embodiments of the disclosure, terminal devices may be configured with appropriate hardware, firmware, and/or software to collect network performance data relating to the performance of various components of the terminal devices. An example terminal device may include, without limitation, a tuner, a channelizer, a modulator/demodulator, a decoder, and so forth. Each of these components may play a role in the processing of an incoming signal (e.g., a digital cable signal) to produce audio and video signals capable of being rendered by an output device such as, for example, a television, a computer monitor, or the like. In addition, based on hardware capabilities of the terminal device, one or more channels may be scanned to capture network performance data relating to an incoming signal. For example, available channels may be scanned in a sequential or random manner.

A tuner may be configured, for example, to select a particular radio frequency (RF) band of an incoming signal. A channelizer may be configured to select a particular channel within a particular RF band. A modulator/demodulator may be configured to demodulate downstream signals and modulate upstream signals. For example, an incoming downstream signal may be modulated in accordance with a suitable modulation technique (e.g., quadrature amplitude modulation (QAM)), and the demodulator/modulator may be configured to demodulate such a signal to extract information-bearing signal(s) from one or more modulated carrier waves. A decoder may be configured to decode the extracted information-bearing signal(s) to retrieve the audio and video information encoded in the signal(s). For example, a digital cable signal may be encoded using a suitable digital compression technique (e.g., Moving Pictures Experts Group (MPEG) Layer 2 compression technology). As another non-limiting example, an Internet Protocol (IP) video signal may be encoded using an MPEG Layer 4 compression technology.

A terminal device in accordance with one or more example embodiments of the disclosure may include one or more processors configured to monitor performance of the example components described above and collect performance data relating to the operation of such components. For example, in an example embodiment of the disclosure, a coprocessor that supplements functions of one or more primary processors may be used to monitor performance and gather performance data. A Linux-based kernel may execute on the coprocessor to perform performance monitoring related operations.

The performance data that is gathered may include, without limitation, data relating to the performance/operation of a tuner, data relating to the performance/operation of a channelizer, data relating to the performance/operation of a modulator/demodulator, data relating to performance/operation of a decoder, and so forth. The performance data may further include data relating to the performance/operation of one or more network interfaces (e.g., an Ethernet interface), one or more input/output interfaces, and so forth.

The terminal device, or more specifically, the one or more processors configured to monitor performance of various components and collect performance data, may be further configured to perform analytics processing to determine whether the performance data satisfies various threshold performance criteria. For example, certain threshold limits may be associated with the performance of various components of the terminal device. If the performance data does not satisfy such threshold limits, the data may be identified as anomalous data indicative of potential network impairment. Threshold limits may include, without limitation, an acceptable number or percentage of correctable bit errors, a threshold signal-to-noise ratio, an error vector magnitude, or the like. In certain example embodiments, an incoming signal received by a terminal device (e.g., an MPEG transport stream) may include encapsulation information (e.g., a well-known sequence (WKS) pre- or post-pended to data packets) to aid in error detection.

A terminal device may also communicate network performance data that it has collected and, potentially, information indicating anomalous data it has identified to one or more neighboring devices in accordance with a suitable peer-to-peer communication protocol. Neighboring devices may include, without limitation, those devices that are connected to the same tap within a cable system architecture. As such, in certain example embodiments, each terminal device may receive network performance data from one or more neighboring devices. In certain example embodiments, a particular terminal device may identify or “discover” neighboring devices in accordance with a suitable protocol. In addition, information relating to a neighboring device may also be discoverable such as, for example, proximity of the neighboring device, capabilities of the neighboring device, and so forth.

In addition to, or in lieu of, anomalous data detection based on a comparison of collected network performance data to threshold performance criteria (e.g., threshold limits), a terminal device may also identify anomalous data based on a comparison of collected network performance data to network performance data received from one or more neighboring devices. For example, collected network performance data that deviates from received network performance data by more than a predetermined tolerance may be identified as anomalous data potentially indicative of a network impairment.

In addition, in certain example embodiments, a terminal device may determine one or more correlations between collected network performance data and network performance data received from neighboring devices and may identify a potential network impairment based on the one or more correlations. More specifically, collected network performance data that a terminal device has identified as anomalous may correlate with network performance data received from neighboring devices, in which case, the terminal device may determine that the anomalous data is indicative of a potential network impairment. For example, a terminal device may determine that a particular component (e.g., a decoder) is exhibiting similar anomalous characteristics across a number of neighboring terminal devices. This may indicate an error in the encoding of the signal received by each of these neighboring terminal devices. It should be appreciated that, in certain example embodiments, a terminal device may identify anomalies based at least in part on a comparison of network performance data received from one or more neighboring devices to one or more threshold limits.

A terminal device may transmit information identifying at least a portion of anomalous data that has been identified to a network management system. Neighboring devices may select a particular device to report anomalous data to the network management system based on a suitable selection protocol. A terminal device may retain network performance data it has collected or received for any suitable period of time to, for example, allow for network performance data to be received from other neighboring devices and for correlations to be identified. The network management system may receive information identifying anomalous data from multiple groups of neighboring devices within the system architecture. In addition, in certain example embodiments, a terminal device associated with a particular group of neighboring devices may transmit information identifying anomalous data to one or more other groups of neighboring devices. Such information may include, for example, a tap location associated with a potential network impairment, a frequency or period of the potential impairment, and so forth.

In certain example embodiments, the network management system may also receive information identifying anomalous data associated with performance of a network edge access device such as, for example, a CMTS, an OLT, a WAP, or the like. For example, the network edge access device may monitor state information relating to transmission conditions associated with corresponding transmission media. Such state information may be provided to the network management system to identify linear and/or non-linear impairments in the transmission media.

The information identifying anomalous data may include the anomalous data itself, a summary of the anomalous data, and so forth. Terminal devices may communicate anomalous data to the network management system using a secure or non-secure mechanism. The secure mechanism may include public key encryption or any other suitable secure form of communication. In addition, neighboring terminal devices may communicate network performance data among one another using a secure or non-secure mechanism.

Upon receipt of the information identifying anomalous data, the network management system may analyze the information to determine if the anomalous data is indicative of a network impairment, and if so, may determine a point of origin of the network impairment. For example, anomalous data received from only a particular group of neighboring devices may indicate a network impairment at a downstream tap that serves that group of devices. On the other hand, similar anomalous data received from multiple groups of neighboring devices along a particular segment may indicate a network impairment at an upstream tap or a fiber node that supplies signals to each tap within the segment. In certain example embodiments, the network management system may identify network impairments in the upstream network traffic and downstream network traffic independently and may perform analytics processing to identify one or more correlations between the upstream and downstream impairments.

In addition, in certain example embodiments, the network management system may be configured to initiate automated network maintenance or recovery to correct or mitigate identified network impairments. The network management system may also receive feedback network data based on which the impact of maintenance or recovery efforts may be determined and additional network maintenance or recovery may be initiated.

Example embodiments of the disclosure provide a number of advantages or technical effects. For example, in accordance with example embodiments of the disclosure, anomalous performance data may be identified and communicated by terminal devices to a network management system to facilitate identification of network impairments without active intervention by the network management system. In addition, in accordance with example embodiments of the disclosure, network performance data may be shared among neighboring devices in order to facilitate identification of anomalous network performance data. Further, terminal devices may determine that anomalous data is correlated among a number of neighboring terminal devices, and thus, may further determine that the anomalous data is indicative of a potential network impairment. In this manner, network impairments may be distinguished from device-specific issues. Still further, in accordance with example embodiments of the disclosure, a particular device among a group of neighboring devices may be selected to report anomalous data to the network management system in order to reduce bandwidth congestion that may otherwise result from all neighboring devices communicating anomalous data to the network management system. It should be appreciated that the above examples of advantages and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative System Architecture and Device Configurations

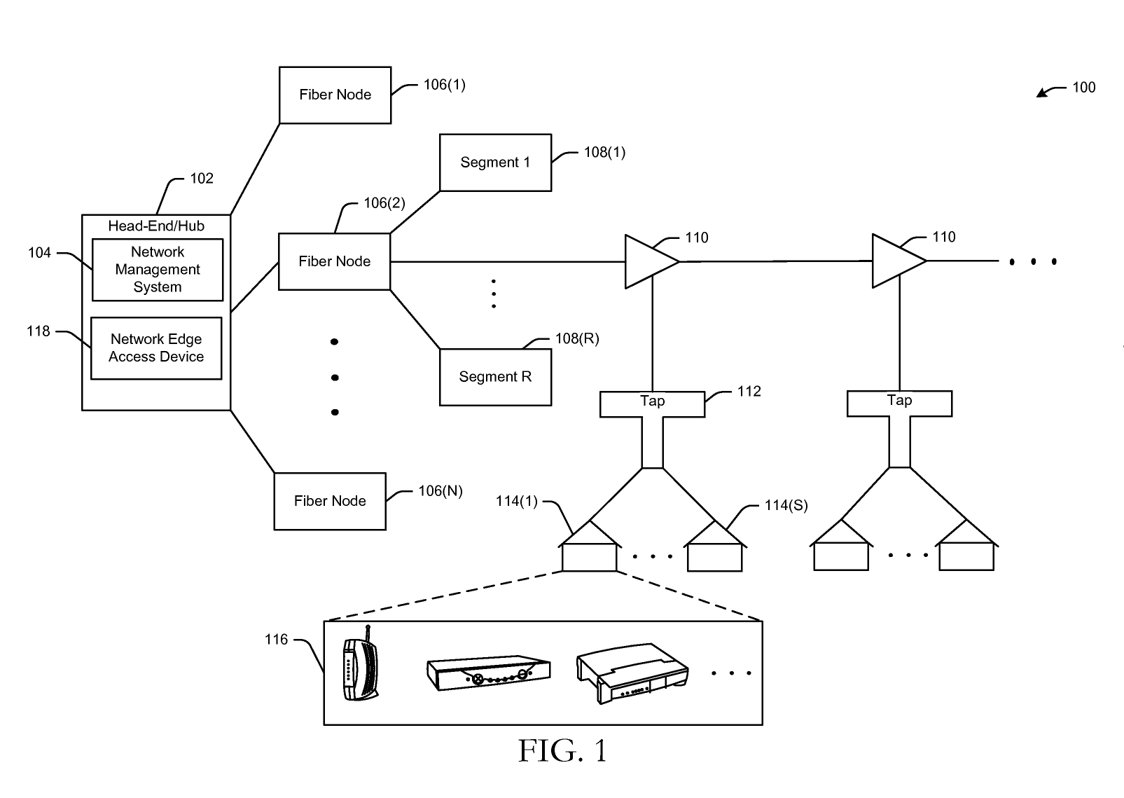

FIG. 1 is a schematic block diagram of an illustrative network architecture 100 in accordance with one or more example embodiments of the disclosure. The architecture 100 may be, for example, a cable system architecture that includes a head-end location 102. Broadcast cable signals may be received via one or more antennas provided at the head-end location 102. The received cable signals may be transmitted from the head-end location 102 via a network edge access device 118 (e.g., a CMTS) to terminal devices 116 (e.g., customer premises equipment) via the cable system architecture 100. The head-end location 102 may further include a network management system 104, which will be described in more detail hereinafter. It should be appreciated that while an example cable system architecture is depicted in FIG. 1, embodiments of the disclosure are not limited to such an architecture or to any particular transmission method or protocol. For example, the network edge access device 118 may be any suitable generic conversion device or termination system (e.g., an OLT, a wireless access point (WAP), etc.) that receives signals transmitted in accordance with a first transmission method (or protocol) and transmits the signals in accordance with a second transmission method (or protocol). Accordingly, the location 102 may be any suitable hub or data aggregation location.

The architecture 100 may be a hybrid fiber-coax architecture that may include a network of optical fiber nodes 106(1)-106(N) connected to the head-end location 102 via optical fiber links. Each fiber node may be associated with one or more segments that may include a series of amplifiers 110 to compensate for signal attenuation and a series of taps that serve particular groups of neighboring terminal devices. For example, fiber node 106(2) may be associated with a particular segment that includes coaxial connections from a main trunk cable to a series of taps 112. Each tap may, in turn, be connected via coaxial connections to a particular group of terminal locations. For example, tap 112 is depicted in FIG. 1 as being connected to premises 114(1)-114(S). Each subscriber premises may include one or more terminal devices 116. As previously noted, any of a variety of terminal devices may be provided as customer premises equipment at a terminal location. Such devices 116 may include, without limitation, cable modems, set-top boxes, residential gateways, fixed mobile convergence devices, home networking adapters, or the like.

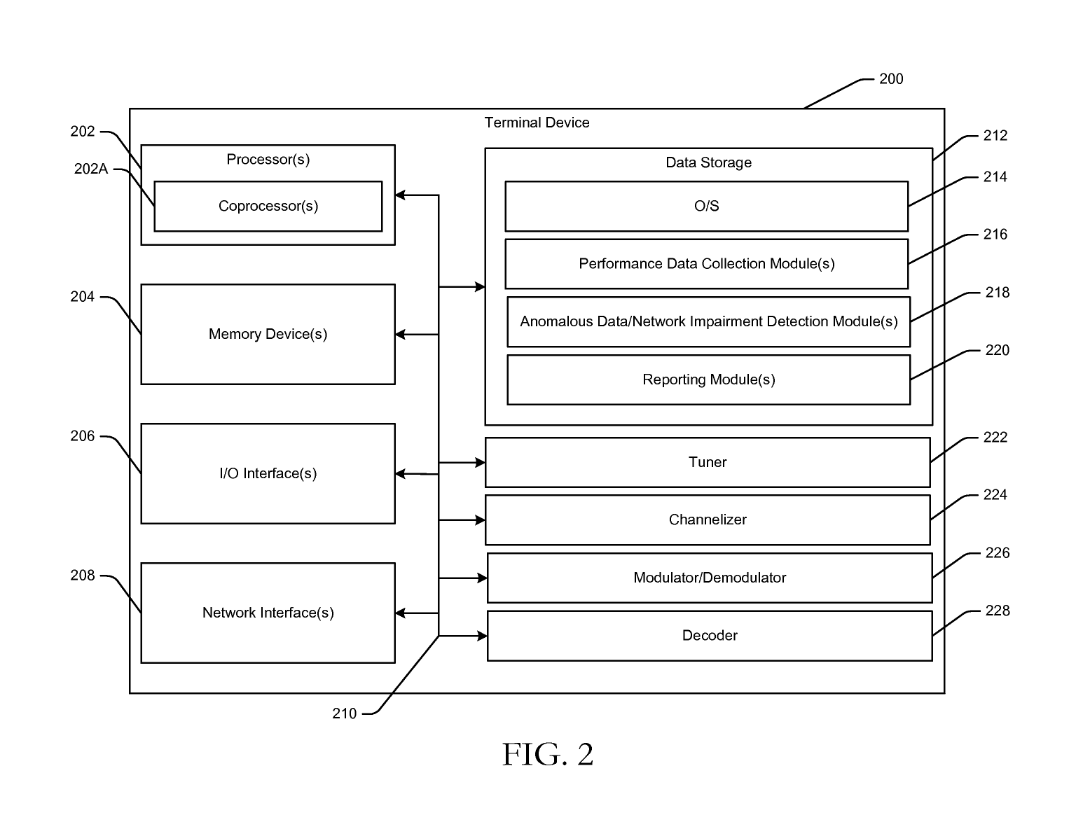

FIG. 2 is a schematic block diagram of an illustrative terminal device 200 in accordance with one or more example embodiments of the disclosure. It should be appreciated that FIG. 2 merely depicts an example configuration for a terminal device in accordance with example embodiments of the disclosure. Numerous other devices configurations are within the scope of the disclosure. The device 200 may be configured to receive and transmit signals (e.g., digital cable signals) via the architecture 100. While the architecture 100 may be described herein as a cable system architecture, it should be appreciated that embodiments of the disclosure are applicable to any suitable network architecture.

More specifically, the device 200 may be configured to communicate with or across any suitable communications network including, but are not limited to, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the device 200 may include one or more processors 202 (which may include one or more coprocessors 202A), one or more memory devices 204 (generically referred to herein as memory 204), one or more input/output (“I/O”) interface(s) 206, one or more network interfaces 208, data storage 212, a tuner 222, a channelizer 224, a modulator/demodulator 226, a decoder 228, and so forth. The device 200 may further include one or more buses 210 that functionally couple various components of the device 200. These various components will be described in more detail hereinafter.

The bus(es) 210 may include at least one of a system bus, a memory bus, an address bus, or a message bus, and may permit exchange of information (e.g., data (including computer-executable code), signaling, etc.) between various components of the device 200. The bus(es) 210 may have any of a variety of bus structures including, without limitation, a memory bus or a memory controller, a peripheral bus, an accelerated graphics port, and so forth. The bus(es) 210 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 204 of the device 200 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 204 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 204 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 212 may include removable storage and/or non-removable storage including, but not limited to, magnetic storage, optical disk storage, and/or tape storage. The data storage 212 may provide non-volatile storage of computer-executable instructions and other data. The memory 204 and the data storage 212, removable and/or non-removable, are examples of computer-readable storage media (CRSM) as that term is used herein.

The data storage 212 may store computer-executable code, instructions, or the like that may be loadable into the memory 204 and executable by the processor(s) 202 to cause various operations to be performed. The data storage 212 may additionally store data that may be copied to memory 204 for use by the processor(s) 202 during the execution of the computer-executable instructions. Moreover, output data generated as a result of execution of the computer-executable instructions by the processor(s) 202 may be stored initially in memory 204, and may ultimately be copied to data storage 212 for non-volatile storage.

More specifically, the data storage 212 may store one or more operating systems (O/S) 214 and one or more program modules, applications, or the like such as, for example, one or more performance data collection modules 216, one or more anomalous data/network impairment detection modules 218, one or more reporting modules 220, or the like. Any of the modules depicted in FIG. 2 may include computer-executable code, instructions, or the like that may be loaded into the memory 204 for execution by one or more of the processor(s) 202.

The processor(s) 202 may be configured to access the memory 204 and execute computer-executable instructions loaded therein. For example, the processor(s) 202 may be configured to execute computer-executable instructions of the various program modules of the terminal device 200 to cause or facilitate various operations to be performed in accordance with one or more embodiments of the disclosure. The processor(s) 202 may include any suitable processing unit capable of accepting data as input, processing the input data in accordance with stored computer-executable instructions, and generating output data. The processor(s) 202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 202 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 202 may be capable of supporting any of a variety of instruction sets.

Referring now to functionality supported by the various program modules depicted in FIG. 2, the performance data collection module(s) 216 may include computer-executable instructions, code, or the like that responsive to execution by one or more of the processor(s) 202 (e.g., a coprocessor 202A) may cause processing to be performed to monitor the operation of one or more components of the terminal device 200 (e.g., the tuner 222, the channelizer 224, etc.) and collect data relating to the performance of such components. The performance data collection module(s) 216 may further include computer-executable instructions, code, or the like that when executed by one or more of the processor(s) 202 may cause processing to be performed to monitor one or more channels to collect performance data indicative of transmission conditions associated with signals received on the one or more channels.

The anomalous data/network impairment detection module(s) 218 may include computer-executable instructions, code, or the like that responsive to execution by one or more of the processor(s) 202 (e.g., a coprocessor 202A) may cause processing to be performed to analyze collected performance data against suitable threshold performance criteria to identify anomalous data that fails to satisfy the criteria. The anomalous data/network impairment detection module(s) 218 may further include computer-executable instructions, code, or the like that responsive to execution by one or more of the processor(s) 202 (e.g., a coprocessor 202A) may cause processing to be performed to identify anomalous data based on a comparison of collected network performance data to network performance data received from neighboring terminal devices. The anomalous data/network impairment detection module(s) 218 may further include computer-executable instructions, code, or the like that responsive to execution by one or more of the processor(s) 202 (e.g., a coprocessor 202A) may cause processing to be performed to identify a network impairment based on a correlation of anomalous collected network performance data to network performance data received from neighboring terminal devices.

The reporting module(s) 220 may include computer-executable instructions, code, or the like that responsive to execution by one or more of the processor(s) 202 (e.g., a coprocessor 202A) may cause information identifying anomalous data to be reported to one or more neighboring terminal devices and/or to the network management system 104.

The O/S 214 may be loaded from the data storage 212 into the memory 204 and may provide an interface between other application software executing on the device 200 and hardware resources of the device 200. More specifically, the O/S 214 may include a set of computer-executable instructions for managing hardware resources of the device 200 and for providing common services to other application programs (e.g., managing memory allocation among various application programs). The O/S 214 may include any operating system now known or which may be developed in the future including, but not limited to, any server operating system, any mainframe operating system, or any other proprietary or non-proprietary operating system.

While not depicted in FIG. 2, the device 200 may further include a database management system (DBMS) such as a lightweight DBMS suitable for the device 200. Such a DBMS may be loaded into the memory 204 and may support functionality for accessing, retrieving, storing, and/or manipulating data stored in the memory 204 and/or data stored in the data storage 212. The DBMS may use any of a variety of database models (e.g., relational model, object model, etc.) and may support any of a variety of query languages. The DBMS may access data represented in one or more data schemas and stored in any suitable data repository.

Other illustrative components of the device 200 that may be configured to receive and process incoming signals (e.g., digital cable signals) will now be described. The tuner 222 may be configured to select a particular radio frequency (RF) band of an incoming signal. The channelizer 224 may be configured to select a particular channel within an RF band. The modulator/demodulator 226 may be configured to demodulate downstream signals and modulate upstream signals. For example, an incoming downstream signal may be modulated in accordance with a suitable modulation technique (e.g., quadrature amplitude modulation (QAM)), and the demodulator/modulator 226 may be configured to demodulate such a signal to extract information-bearing signal(s) from one or more modulated carrier waves. The decoder 228 may be configured to decode the extracted information-bearing signal(s) to retrieve the audio and video information encoded in the signal(s). The signals may be encoded using any suitable encoding technique such as, for example, MPEG Layer 2, MPEG Layer 4, or the like.

Referring now to other illustrative components of the device 200, one or more input/output (I/O) interfaces 206 may be provided that may facilitate the receipt of input information by the device 200 from one or more I/O devices as well as the output of information from the device 200 to the one or more I/O devices. The I/O devices may include, for example, one or more user interface devices that facilitate interaction between a user and the device 200 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

The device 200 may further include one or more network interfaces 208 (e.g., an Ethernet interface) via which the device 200 may communicate with any of a variety of other systems, platforms, networks, devices, and so forth. Such communication may occur via any of the types of networks previously described.

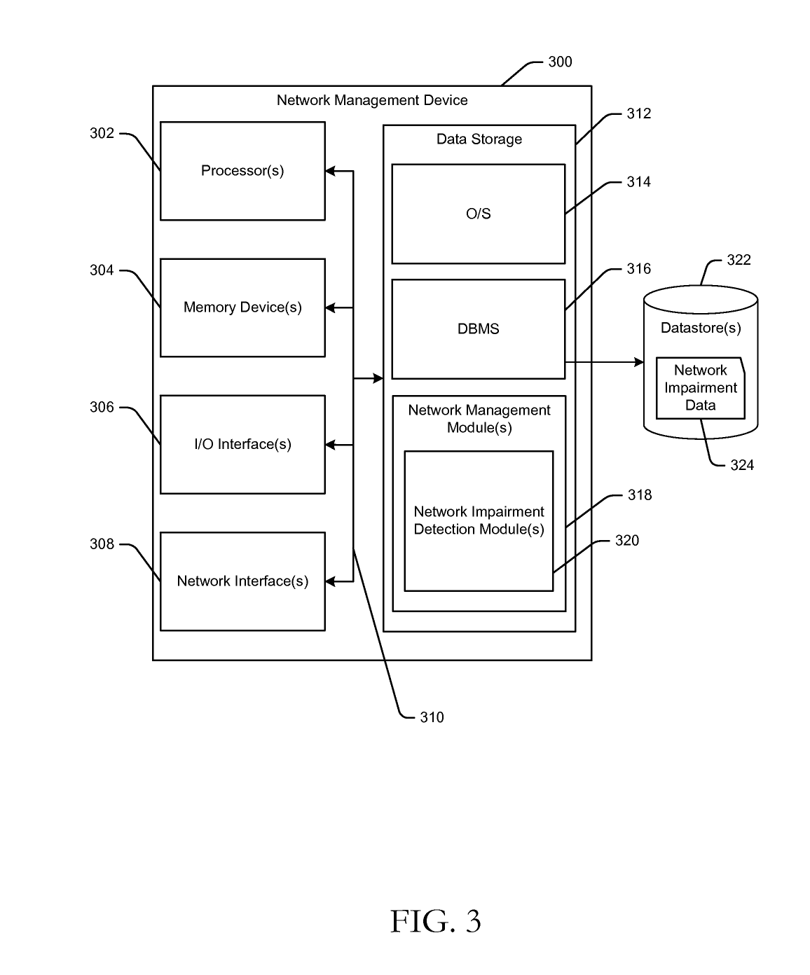

FIG. 3 is a schematic block diagram of an illustrative network management system device 300 in accordance with one or more example embodiments of the disclosure. It should be appreciated that FIG. 3 merely depicts an example configuration for a network management system device in accordance with example embodiments of the disclosure. Numerous other device configurations are within the scope of the disclosure. The device 300 may be configured to receive and transmit signals (e.g., digital cable signals) via the architecture 100. More specifically, the device 300 may be configured to communicate with or across any suitable communications network including any of the types of networks previously described with reference to FIG. 2.

In an illustrative configuration, the device 300 may include one or more processors 302, one or more memory devices 304 (generically referred to herein as memory 304), one or more input/output (“I/O”) interface(s) 306, one or more network interfaces 308, and data storage 312. The device 300 may further include one or more buses 310 that functionally couple various components of the device 300. These various components will be described in more detail hereinafter.

The bus(es) 310 may include any of the types of buses previously described with reference to the bus(es) 210 depicted in FIG. 2. In addition, the bus(es) 310 may be associated with any suitable bus architecture including any of those previously described with reference to the bus(es) 210.

The memory 304 of the device 300 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. In certain example embodiments, volatile memory may enable faster read/write access than non-volatile memory. However, in certain other example embodiments, certain types of non-volatile memory (e.g., FRAM) may enable faster read/write access than certain types of volatile memory. In various implementations, the memory 304 may include multiple different types of memory including any of the types of memory described with reference to the memory 204 of device 200.

The data storage 312 may include removable storage and/or non-removable storage including, but not limited to, magnetic storage, optical disk storage, and/or tape storage. The data storage 312 may provide non-volatile storage of computer-executable instructions and other data. The memory 304 and the data storage 312, removable and/or non-removable, are examples of computer-readable storage media (CRSM) as that term is used herein.

The data storage 312 may store computer-executable code, instructions, or the like that may be loadable into the memory 304 and executable by the processor(s) 302 to cause various operations to be performed. The data storage 312 may additionally store data that may be copied to memory 304 for use by the processor(s) 302 during the execution of the computer-executable instructions. Moreover, output data generated as a result of execution of the computer-executable instructions by the processor(s) 302 may be stored initially in memory 304, and may ultimately be copied to data storage 312 for non-volatile storage.

More specifically, the data storage 312 may store one or more operating systems (O/S) 314, one or more database management systems (DBMS) 316, and one or more program modules, applications, or the like such as, for example, one or more network management modules 318 which may, in turn, include one or more network impairment detection module(s) 320. Any of the modules depicted in FIG. 3 may include computer-executable code, instructions, or the like that may be loaded into the memory 304 for execution by one or more of the processor(s) 302.

The processor(s) 302 may be configured to access the memory 304 and execute computer-executable instructions loaded therein. For example, the processor(s) 302 may be configured to execute computer-executable instructions of the various program modules of the user device 304 to cause or facilitate various operations to be performed in accordance with one or more embodiments of the disclosure. The processor(s) 302 may include any suitable processing unit capable of accepting data as input, processing the input data in accordance with stored computer-executable instructions, and generating output data. The processor(s) 302 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 302 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 302 may be capable of supporting any of a variety of instruction sets.

Referring now to functionality supported by the various program modules depicted in FIG. 3, the network management module(s) 318 may include computer-executable instructions, code, or the like that responsive to execution by one or more of the processor(s) 302 may cause processing to be performed to manage operation of a network architecture (e.g., the network architecture 100). Bandwidth allocation and use, quality of service guarantees, or the like may be managed by the network management module(s) 318. In addition, the network management module(s) 318 may include computer-executable instructions, code, or the like that responsive to execution by one or more of the processor(s) 302 may cause automated network maintenance or recovery processing to be initiated, and optionally, modified based on network feedback data.

The network impairment detection module(s) 320 may include computer-executable instructions, code, or the like that responsive to execution by one or more of the processor(s) 302 may cause processing to be performed to analyze anomalous data received from terminal devices and/or a network edge access device to determine if the data is indicative of a network impairment, and if so, may further cause processing to be performed to identify a point of origin of the network impairment. For example, anomalous data received from only a particular group of neighboring devices may indicate a network impairment at a downstream tap that serves that group of devices. On the other hand, similar anomalous data received from multiple groups of neighboring devices along a particular segment may indicate a network impairment at an upstream tap or a fiber node that supplies signals to each tap within the segment.

The O/S 314 may be loaded from the data storage 312 into the memory 304 and may provide an interface between other application software executing on the device 300 and hardware resources of the device 300. More specifically, the O/S 314 may include a set of computer-executable instructions for managing hardware resources of the device 300 and for providing common services to other application programs (e.g., managing memory allocation among various application programs). The O/S 314 may include any operating system now known or which may be developed in the future including, but not limited to, any server operating system, any mainframe operating system, or any other proprietary or non-proprietary operating system.

The DBMS 316 may be loaded into the memory 304 and may support functionality for accessing, retrieving, storing, and/or manipulating data stored in the memory 304 and/or data stored in the data storage 312. The DBMS 316 may use any of a variety of database models (e.g., relational model, object model, etc.) and may support any of a variety of query languages. The DBMS 316 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. For example, the DBMS 316 may retrieve and store data in one or more datastores 322. Such data may include, for example, network impairment data 324 which may include anomalous data received from terminal devices and/or a network edge access device as well as any data generated as a result of analysis of the received anomalous data.

Referring now to other illustrative components of the device 300, one or more input/output (I/O) interfaces 306 may be provided that may facilitate the receipt of input information by the device 300 from one or more I/O devices as well as the output of information from the device 300 to the one or more I/O devices. The I/O devices may include, for example, one or more user interface devices that facilitate interaction between a user and the device 300 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

The device 300 may further include one or more network interfaces 308 (e.g., an Ethernet interface) via which the device 300 may communicate with any of a variety of other systems, platforms, networks, devices, and so forth. Such communication may occur via any of the types of networks previously described.

It should be appreciated that the program modules, applications, computer-executable instructions, code, or the like depicted in FIG. 2 as being stored in the data storage 212 or in FIG. 3 as being stored in the data storage 312 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the device 200 or the device 300, and/or hosted on other computing device(s) accessible via one or more networks, may be provided to support functionality provided by the program modules, applications, or computer-executable code depicted in FIG. 2 or in FIG. 3 and/or additional or alternate functionality. Further, functionality may be modularized differently such that processing described as being supported collectively by the collection of program modules depicted in FIG. 2 or the collection of program modules depicted in FIG. 3 may be performed by a fewer or greater number of modules, or functionality described as being supported by any particular module may be supported, at least in part, by another module. In addition, program modules that support the functionality described herein may form part of one or more applications executable across any number of systems or devices of the architecture 100 in accordance with any suitable computing model such as, for example, a client-server model, a peer-to-peer model, and so forth. In addition, any of the functionality described as being supported by any of the program modules depicted in FIG. 2 or the program modules depicted in FIG. 3 may be implemented, at least partially, in hardware and/or firmware across any number of devices.

It should further be appreciated that the device 200 or the device 300 may include alternate and/or additional hardware, software, or firmware components beyond those described or depicted without departing from the scope of the disclosure. More particularly, it should be appreciated that software, firmware, or hardware components depicted as forming part of the device 200 or the device 300 are merely illustrative and that some components may not be present or additional components may be provided in various embodiments. While various illustrative program modules have been depicted and described as software modules stored in data storage, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

### Illustrative Processes

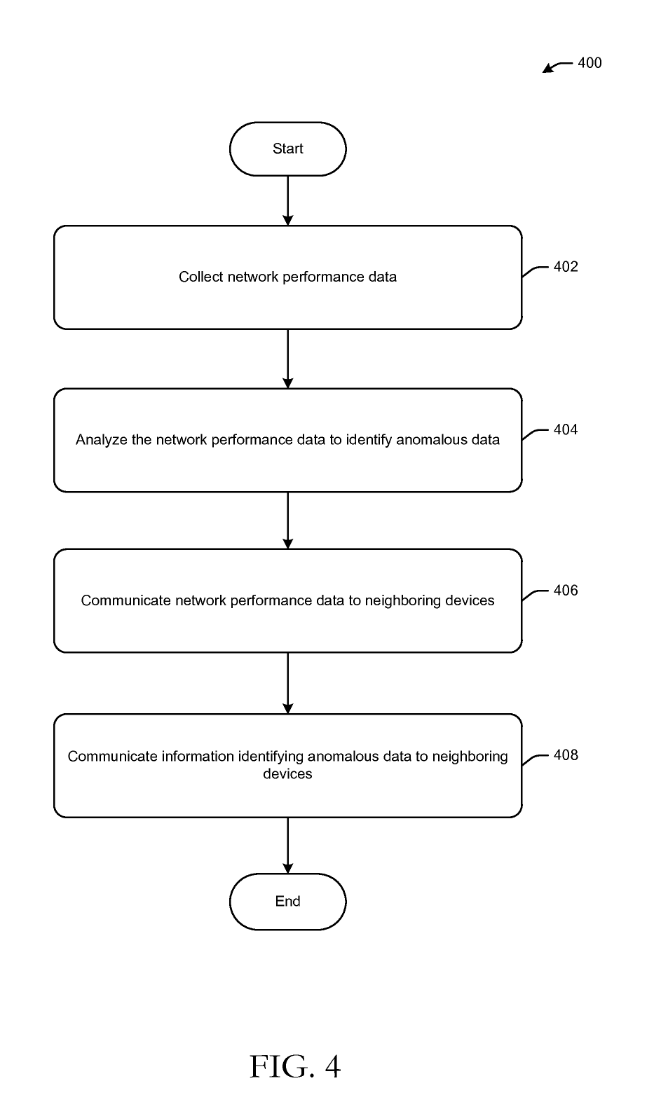

FIG. 4 is a process flow diagram of an illustrative method 400 for identifying anomalous data from collected network performance data and communicating the collected network performance data to neighboring terminal devices to facilitate further identification of anomalous data by the neighboring terminal devices in accordance with one or more example embodiments of the disclosure.

At block 302, a terminal device in accordance with one or more example embodiments of the disclosure may monitor the performance of one or more internal components and collect performance data relating to the operation of such components. More specifically, one or more of the processor(s) 202 of a device 200 (e.g., a coprocessor 202A) may execute computer-executable instructions of the performance data collection module(s) 216 to monitor component performance and gather performance data. In certain example embodiments, the performance data collection module(s) 216 may include a Linux-based kernel or the like that may execute on the coprocessor 202A to perform performance monitoring related operations. In addition, the terminal device may monitor one or more transmission channels and collect performance data relating to transmission conditions associated with the monitored channels.

The performance data that is gathered may include, without limitation, data relating to the performance/operation of the tuner 222, data relating to the performance/operation of the channelizer 224, data relating to the performance/operation of the modulator/demodulator 226, data relating to performance/operation of the decoder 228, and so forth. The performance data may further include data relating to the performance/operation of one or more of the network interface(s) 208 (e.g., an Ethernet interface), one or more of the input/output interface(s) 206, and so forth. In addition, as previously noted, the performance data may include data relating to transmission conditions on one or more monitored channels.

At block 404, computer-executable instructions of the anomalous data/network impairment detection module(s) 218 may be executed to perform analytics processing on the collected performance data to determine whether the performance data satisfies various threshold performance criteria. For example, certain threshold limits may be associated with the performance of various components of the terminal device 200. If the performance data does not satisfy such threshold criteria, the data may be regarded as anomalous data indicative of a potential network impairment. Threshold limits may include, without limitation, an acceptable number or percentage of correctable bit errors, an error vector magnitude, or the like.

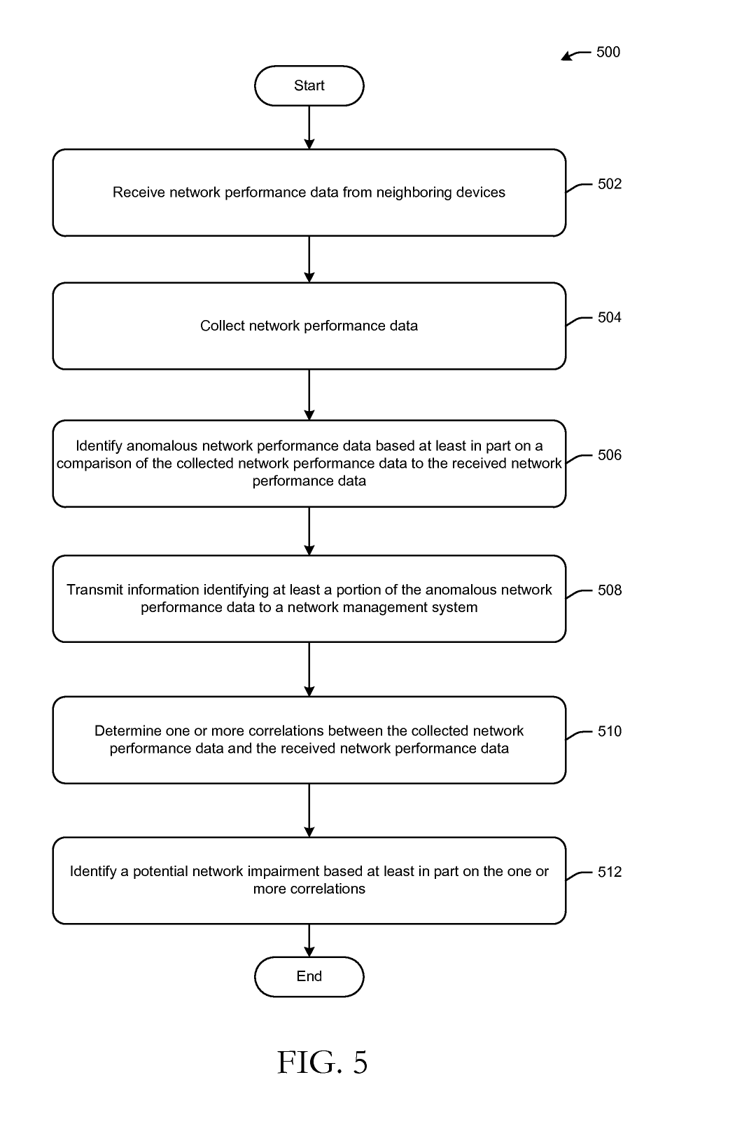

At block 406, computer-executable instructions of the reporting module(s) 220 may be executed to communicate the network performance data to one or more neighboring terminal devices in accordance with a suitable peer-to-peer communication protocol. Alternatively, or additionally, network performance data may be communicated between neighboring devices using, for example, a messaging protocol that uses a decentralized client-server architecture such as the Extensible Messaging and Presence Protocol (XMPP). In this manner, each terminal device may receive network performance data from one or more neighboring devices. As will be described in more detail with reference to FIG. 5, the neighboring terminal devices may identify anomalous network performance data by comparing their collected network performance data to the received data.

At block 408, computer-executable instructions of the reporting module(s) 220 may be executed to communicate information identifying the anomalous data identified at block 404 to one or more neighboring devices. In certain example embodiments, the neighboring devices may utilize the information communicated at block 408 to assess whether their collected network performance data demonstrates similar anomalous characteristics.

FIG. 5 is a process flow diagram of an illustrative method 500 for, among other things, receiving network performance data from neighboring terminal devices, identifying anomalous data based on a comparison of collected network performance data to the received network performance data, and transmitting information identifying at least a portion of the anomalous data to a network management system in accordance with one or more example embodiments of the disclosure.

At block 502, a terminal device 200 may receive network performance data from one or more neighboring terminal devices. At block 504, the terminal device 200 may collect network performance data. The network performance data may include any of example types of data previously described and may be collected in accordance with any of the mechanisms described herein.

At block 506, computer-executable instructions of the anomalous data/network impairment detection module(s) 218 may be executed to identify anomalous network performance data based at least in part on a comparison of the collected network performance data to the received network performance data. Information may be received from neighboring devices that identifies anomalous data present in the network performance data received from the neighboring devices, and may be utilized by the terminal device to facilitate identification of the anomalous data.

At block 508, computer-executable instructions of the reporting module(s) 220 may be executed to cause information identifying at least a portion of the anomalous data to be transmitted to a network management system device 300. A particular terminal device may be selected to report anomalous data to the network management system based on a suitable selection protocol.

At block 510, computer-executable instructions of the anomalous data/network impairment detection module(s) 218 may be executed to determine one or more correlations between the collected network performance data and the received network performance data. For example, the anomalous data identified at block 506 may be correlated with at least a portion of the network performance data received from neighboring devices. At block 512, computer-executable instructions of the anomalous data/network impairment detection module(s) 218 may be executed to identify a potential network impairment based at least in part on the one or more correlations. For example, at block 510, it may be determined that a particular component (e.g., the modulator/demodulator 226) is exhibiting similar anomalous characteristics across a number of neighboring terminal devices. Then, at block 512, a signal modulation error may be identified as the potential network impairment.

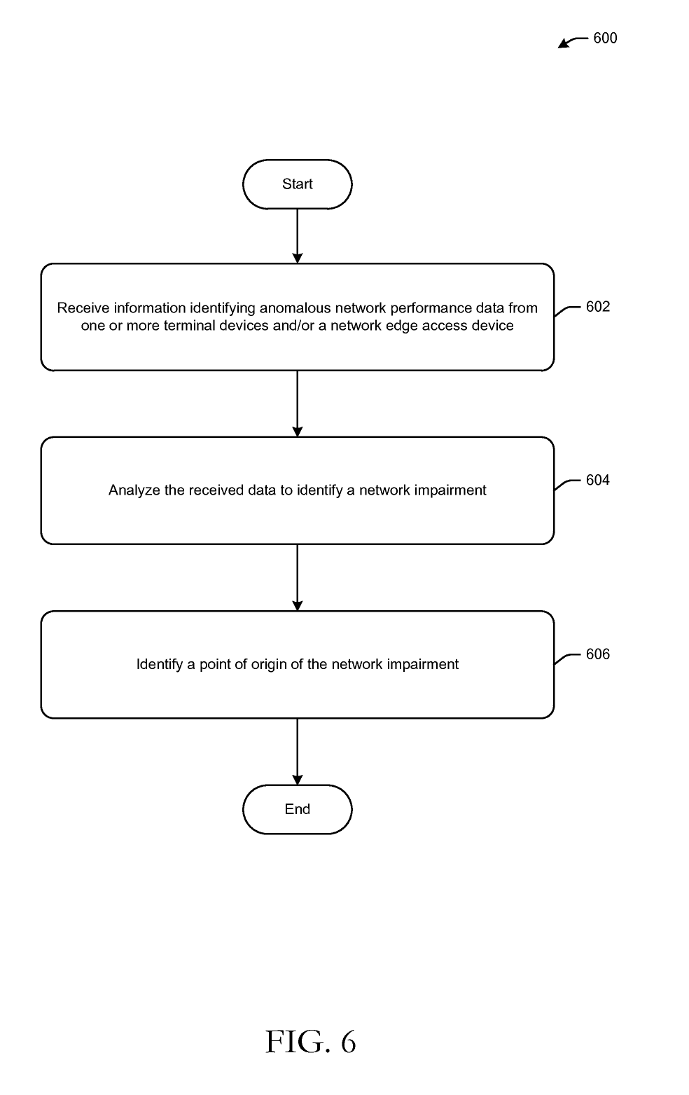

FIG. 6 is a process flow diagram of an illustrative method 600 for receiving anomalous network performance data and identifying a network impairment and a point of origin of the network impairment based at least in part on the received anomalous data in accordance with one or more example embodiments of the disclosure.

At block 602, a computing device 300 of the network management system may receive information from multiple groups of neighboring terminal devices within the system architecture 100 indicative of anomalous data identified by the terminal devices. In addition, the computing device 300 may receive information identifying anomalous network data from a network edge access device.

At block 604, computer-executable instructions of the network impairment detection module(s) 320 may be executed to analyze the anomalous data to determine if the data is indicative of network impairment.

If a network impairment is identified, at block 606, computer-executable instructions of the network impairment detection module(s) 320 may be executed to identify a point of origin of the network impairment. For example, anomalous data associated with only a particular group of neighboring devices may indicate network impairment at a downstream tap that serves that group of devices. On the other hand, similar anomalous data associated with multiple groups of neighboring devices along a particular segment may indicate network impairment at an upstream tap or a fiber node that supplies signals to each tap within the segment. Although not depicted in FIG. 6, it should be appreciated that the device 300 may initiate network maintenance or recovery processing to correct or mitigate an identified network impairment.

One or more operations of the methods 400 or 500 may have been described above as being performed by a device 200, or more specifically, by one or more program modules, applications, or the like executing on the device 200. It should be appreciated, however, that any of the operations of methods 400 or 500 may be performed, at least in part, in a distributed manner by one or more other devices, or more specifically, by one or more program modules, applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the methods 400 or 500 may be described in the context of the illustrative device 200, it should be appreciated that such operations may be implemented in connection with numerous other device configurations.

Similarly, one or more operations of the method 600 may have been described above as being performed by a device 300, or more specifically, by one or more program modules, applications, or the like executing on the device 300. It should be appreciated, however, that any of the operations of method 600 may be performed, at least in part, in a distributed manner by one or more other devices, or more specifically, by one or more program modules, applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the method 600 may be described in the context of the illustrative device 300, it should be appreciated that such operations may be implemented in connection with numerous other device configurations.

The operations described and depicted in the illustrative methods of FIGS. 4-6 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 4-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program modules, applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method, comprising:
collecting, by a terminal device comprising one or more computer processors, network performance data indicative of at least one of: i) one or more performance characteristics of one or more components of the terminal device or ii) one or more network transmission characteristics;
analyzing, by the terminal device, the network performance data based at least in part on at least one of: i) one or more threshold network performance criteria or ii) network performance data received from at least one neighboring terminal device of one or more neighboring terminal devices, to identify anomalous network performance data; and
communicating, by the terminal device, at least a portion of the network performance data to the one or more neighboring terminal devices.

2. The method of claim 1, wherein the terminal device is a first terminal device and the network performance data is first network performance data, the method further comprising:
receiving, by the first terminal device, second network performance data from a second terminal device included in the one or more neighboring terminal devices,
wherein analyzing the first network performance data comprises:
determining, by the first terminal device, that at least a portion of the first network performance data deviates from the second network performance data by more than a threshold tolerance; and
identifying, by the first terminal device, the at least a portion of the first network performance data as the anomalous data.

3. The method of claim 1, further comprising:
determining, by the terminal device, one or more correlations between the anomalous data and the network performance data received from the at least neighboring terminal device; and
identifying, by the terminal device, a potential network impairment based at least in part on the one or more correlations.

4. The method of claim 3, wherein determining the one or more correlations comprises:
determining that the anomalous data indicates a first set of one or more anomalous characteristics and the network performance data received from the at least one neighboring device indicates a second set of one or more anomalous characteristics; and
determining that the first set of anomalous characteristics corresponds to the second set of anomalous characteristics.

5. The method of claim 3, further comprising:
transmitting, by terminal device, information identifying the anomalous data to a network management system configured to perform one or more network maintenance or recovery operations.

6. The method of claim 5, wherein the terminal device is designated for transmitting the information identifying the anomalous data based at least in part on a selection protocol.

7. The method of claim 5, wherein the information identifying the anomalous data is encrypted prior to transmission.

8. The method of claim 1, wherein analyzing the network performance data comprises determining whether the network performance data satisfies one or more threshold network performance limits.

9. The method of claim 8, wherein the one or more threshold network performance limits comprise at least one of a threshold number or percentage of correctable bit errors, a threshold signal-to-noise ratio, or a threshold error vector magnitude.

10. A terminal device, comprising:
one or more signal processing components;
at least one processor; and
at least one memory storing computer-executable instructions, wherein the at least one processor is configured to access the at least one memory and execute the computer-executable instructions to:
collect network performance data indicative of at least one of: i) one or more performance characteristics of at least one of the one or more signal processing components or ii) one or more network transmission characteristics;
analyze the network performance data based at least in part on at least one of: i) one or more threshold network performance criteria or ii) network performance data received from at least one neighboring terminal device of one or more neighboring terminal devices, to identify anomalous network performance data; and
direct communication of at least a portion of the network performance data to the one or more neighboring terminal devices.

11. The terminal device of claim 10, wherein the terminal device is a first terminal device and the network performance data is first network performance data, and wherein the at least one processor is further configured to execute the computer-executable instructions to:
receive second network performance data from a second terminal device included in the one or more neighboring terminal devices,
wherein the at least one processor is configured to analyze the first network performance data by executing the computer-executable instructions to:
determine that at least a portion of the first network performance data deviates from the second network performance data by more than a threshold tolerance; and
identify the at least a portion of the first network performance data as the anomalous data.

12. The terminal device of claim 10, wherein the at least one processor is further configured to execute the computer-executable instructions to:
determine one or more correlations between the anomalous data and the network performance data received from the at least neighboring terminal device; and
identify a potential network impairment based at least in part on the one or more correlations.

13. The terminal device of claim 12, wherein the at least one processor is configured to determine the one or more correlations by executing the computer-executable instructions to:
determine the anomalous data indicates a first set of one or more anomalous characteristics and the network performance data received from the at least one neighboring device indicates a second set of one or more anomalous characteristics; and
determine that the first set of anomalous characteristics corresponds to the second set of anomalous characteristics.

14. The terminal device of claim 12, wherein the at least one processor is further configured to execute the computer-executable instructions to:
direct transmission of information identifying the anomalous data to a network management system configured to perform one or more network maintenance or recovery operations.

15. The terminal device of claim 10, wherein the at least one processor is configured to analyze the network performance data by executing the computer-executable instructions to determine whether the network performance data satisfies one or more threshold network performance limits.

16. The terminal device of claim 15, wherein the one or more threshold network performance limits comprise at least one of a threshold number or percentage of correctable bit errors, a threshold signal-to-noise ratio, or a threshold error vector magnitude.

17. The terminal device of claim 10, wherein the one or more signal processing components comprise at least one of a tuner, a channelizer, a modulator/demodulator, or a decoder.

18. A network management system, comprising:
at least one processor; and
at least one memory storing computer-executable instructions, wherein the at least one processor is configured to access the at least one memory and execute the computer-executable instructions to:
receive anomalous network performance data from at least one of: i) one or more groups of neighboring terminal devices or ii) a network edge access device;
analyze the anomalous network performance data to identify a network impairment; and
determine a point of origin of the network impairment.

19. The network management system of claim 18, wherein the at least one processor is configured to determine the point of origin of the network impairment by executing the computer-executable instructions to determine that the network impairment is located upstream from a tap associated with a particular group of neighboring terminal devices.

20. The network management system of claim 18, wherein the anomalous network performance data comprises first anomalous data received from a first group of neighboring terminal devices associated with a first tap and second anomalous data received from a second group of neighboring terminal devices associated with a second tap, and wherein the at least one processor is configured to analyze the anomalous network performance data to identify the network impairment by executing the computer-executable instructions to:
determine that the first anomalous data indicates a first set of anomalous characteristics associated with the first group of neighboring devices;
determine that the second anomalous data indicates a second set of anomalous performance characteristics associated with the second group of neighboring devices; and
determine that the first set of anomalous characteristics corresponds the second set of anomalous characteristics.

21. The network management system of claim 20, wherein the at least one processor is further configured to analyze the anomalous network performance data to identify the network impairment by executing the computer-executable instructions to:
determine that the first set of anomalous characteristics is associated with a first set of one or more components of the first group of neighboring devices and the second set of anomalous characteristics is associated with a second set of one or more components of the second group of neighboring devices; and
determine that the first set of components is associated with first functionality that corresponds to second functionality associated with the second set of components.

22. The network management system of claim 20, wherein the at least one processor is configured to determine the point of origin of the network impairment by executing the computer-executable instructions to:
determine that the point of origin is upstream from the first tap and the second tap.

23. The network management system of claim 18, wherein the anomalous network performance data comprises anomalous upstream network performance data and anomalous downstream network performance data, wherein the network impairment is a first network impairment identified based at least in part on the anomalous upstream network performance data, and wherein the at least one processor is further configured to execute the computer-executable instructions to:
identify a second network impairment based at least in part on the downstream anomalous network performance data;
correlate the first network impairment with the second network impairment; and
determine the point of origin based at least in part on the correlation of the first network impairment with the second network impairment.

24. The network management system of claim 18, wherein the at least one processor is further configured to execute the computer-executable instructions to:
initiate automated network maintenance or recovery processing to resolve or mitigate the network impairment.
